(19) United States
(12) Patent Application Publication
(10) Pub. No.: US 2018/0008932 A1
(43) Pub. Date: Jan. 11, 2018

(54) DEF DOSING FOR SELECTIVE CATALYTIC REDUCTION CATALYSTS

(71) Applicant: GM GLOBAL TECHNOLOGY OPERATIONS LLC, DETROIT, MI (US)

(72) Inventors: David P. Quigley, Brighton, MI (US); Sarah Funk, Canton, MI (US); Pablo E. Hernandez Garcia, Royal Oak, MI (US); Amr M. Radwan, Canton, MI (US)

(21) Appl. No.: 15/206,481

(22) Filed: Jul. 11, 2016

(51) Int. Cl. B01D 53/94; F01N 11/00; F01N 3/20

(52) U.S. Cl. CPC B01D 53/9495; B01D 53/9431; F01N 3/208; F01N 11/002; B01D 2251/2062; F01N 2610/02; F01N 2900/0402; F01N 2900/1404; F01N 2550/02

(57) ABSTRACT

A method to reduce NOx breakthrough and NH3 slip is provided when the SCR system is increasing in temperature and/or increasing exhaust gas mass flow. The method includes the steps of monitoring states of parameters of the exhaust gas upstream of an SCR catalyst where the states of parameters include at least one of the inlet temperature or the exhaust gas mass flow; identifying one of a temperature increase or an increased exhaust gas mass flow at the SCR inlet; identifying a new lower ammonia set-point or storage concentration for the SCR; and identifying the rate of NH3 consumption. The method further includes the step of determining an “intervening phase” a small dosage of DEF is continued during the intervening phase.

### TECHNICAL FIELD

The present disclosure relates to emission control systems, and more particularly to controlling an ammonia storage level in a selective catalytic reduction system to prevent NOx breakthrough and NH3 slip.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Engines emit exhaust gas that includes carbon monoxide (CO), hydrocarbons (HC), and nitrogen oxides (NOₓ). An exhaust treatment system reduces the levels of CO, HC, and NOₓ in the exhaust gas. The exhaust treatment system may include an oxidation catalyst (OC) (e.g., a diesel OC), an (optional) particulate filter (PF) (e.g., a diesel PF), and a selective catalytic reduction (SCR) system. The OC oxidizes CO and HC to form carbon dioxide and water. The PF removes particulate matter from the exhaust gas. The SCR system reduces NOₓ.

The SCR system injects a reducing agent (e.g., urea) into the exhaust gas upstream from an SCR catalyst. The reducing agent forms ammonia that reacts with NOₓ in the SCR catalyst. The reaction of ammonia and NOₓ in the SCR catalyst reduces the NOₓ and results in the emission of diatomic nitrogen and water. When excess reducing agent is injected into the exhaust gas, the excess reducing agent may form excess ammonia that passes through the SCR catalyst without reacting.

### SUMMARY

The present disclosure provides a method for preventing NOx breakthrough and NH3 slip when the SCR system experiences a sudden increase in temperature or a sudden increase in exhaust gas mass flow. The method includes the steps of monitoring states of parameters of the exhaust gas feed-stream upstream of the ammonia-selective catalyst reduction device where the states of parameters include at least one of the inlet temperature and/or the exhaust gas mass flow; identifying one of a temperature increase or exhaust gas mass flow increase at the SCR inlet; identifying a new lower ammonia set-point for the SCR brick; and identifying the rate of NH₃ consumption. The method further includes the step of determining an “intervening phase” where the NH₃ will be consumed and continuing a small dosage of DEF, during the intervening phase. The method further includes checking the new lower ammonia set point against the actual NH₃ concentration; and resuming back to the default DEF dosage if the new lower ammonia set point matches the actual NH₃ concentration.

### BRIEF DESCRIPTION OF THE DRAWINGS

FIG. 1 illustrates a functional block diagram of an engine system of the present disclosure.

FIG. 2 illustrates a graph of an SCR system conversion ratio according to the present disclosure.

FIG. 3 illustrates a functional block diagram of an ECM according to the present disclosure.

FIG. 4 is a graph that illustrates how the conversion ratio changes in the SCR catalyst as the temperature changes.

FIG. 5 is a graph which illustrates the change in the optimum storage level of an SCR catalyst when the SCR temperature changes from 250 to 300 degrees Celsius.

FIG. 6 illustrates graph data for the SCR temperature, NH₃ load, and NOx output of the SCR for different DEF dosing methods.

FIG. 7 is a schematic diagram of an example algorithmic flowchart for sequentially determining ammonia storage in a stepwise fashion for each discrete substrate element over an elapsed period of time for an SCR catalyst.

FIG. 8 illustrates a flowchart of the method for dosing DEF after a temperature increase or an exhaust gas mass flow increase in order to reduce NOx breakthrough according to embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations. Moreover, it should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

A selective catalytic reduction (SCR) system reduces nitrogen oxides (NOx) in exhaust gas. The SCR system includes a reducing agent injector that injects a reducing agent (DEF—Diesel Exhaust Fluid) into exhaust gas to form ammonia (NH₃). NH₃ may be released from the SCR system, for example, when the reducing agent injector injects excess reducing agent or when the temperature of the SCR system increases. Release of NH₃ from the SCR system may be referred to hereinafter as “NH₃ slip.”

A storage level determination system according to the present disclosure determines an optimum NH₃ storage level for the SCR catalyst to prevent both NH₃ slip and NOₓ breakthrough after there is a surge in temperature or increase in exhaust gas mass flow. The optimum NH₃ storage level may be a storage level that maximizes NOₓ conversion efficiency of the SCR catalyst while minimizing the probability of NH₃ slip due to transient operating conditions (e.g., a change in SCR temperature or exhaust flow). The storage level determination system determines the optimum NH₃ storage level of the SCR catalyst using an SCR model. For example, the storage level determination system may determine whether an initial storage level is optimum based on modeling the effects of temperature and storage level perturbations on the initial storage level using the SCR model and may adjust the amount of ammonia on the SCR brick to have maximum conversion efficiency while preventing NOₓ and NH₃ breakthrough.

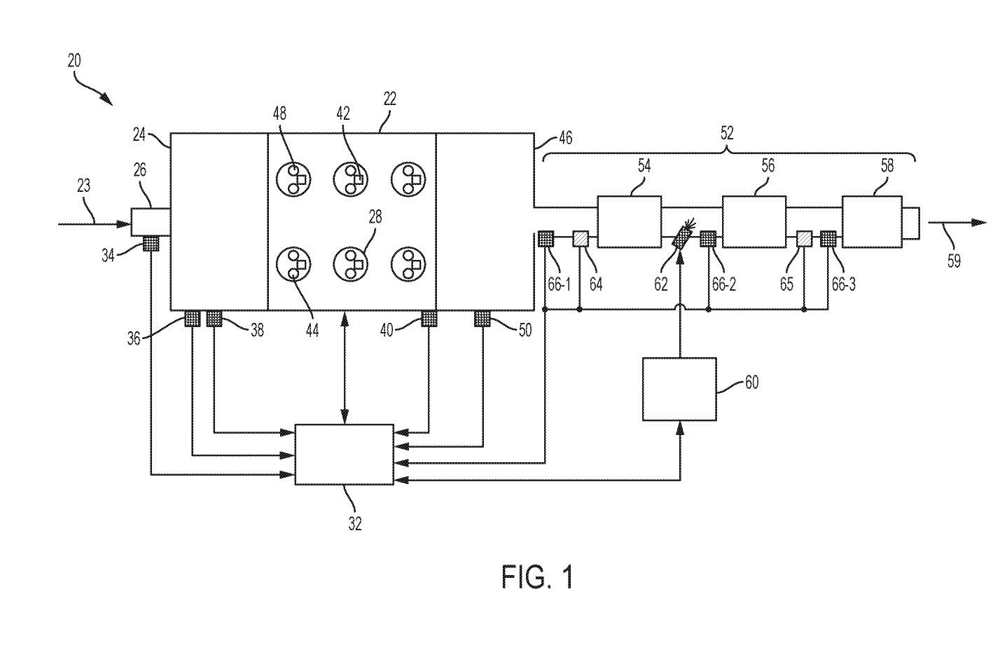

Referring now to FIG. 1, an engine system 20 (e.g., a diesel engine system) includes an engine 22 that combusts an air/fuel mixture to produce drive torque. Air 23 is drawn into an intake manifold 24 through an inlet 26. A throttle (not shown) may be included to regulate air flow into the intake manifold 24. Air within the intake manifold 24 is distributed into cylinders 28. Although FIG. 1 depicts six cylinders 28, the engine 22 may include additional or fewer cylinders 28. Although a compression ignition engine is illustrated, a spark ignition engine is also contemplated.

The engine system 20 includes an engine control module (ECM) 32 that communicates with components of the engine system 20 including but not limited to sensors 34, 36, 38, 40, 50. The components may include the engine 22, exhaust sensors, and actuators as discussed herein. The ECM 32 may implement the NH₃ storage level determination system and method of the present disclosure.

The ECM 32 actuates fuel injectors 42 to inject fuel into the cylinders 28. An intake valve 44 selectively opens and closes to enable air to enter the cylinder 28. An intake camshaft (not shown) regulates a position of the intake valve 44. A piston (not shown) compresses and combusts the air/fuel mixture within the cylinder 28. Alternatively, the air/fuel mixture may be ignited using a spark plug in a spark ignition engine. The piston drives the crankshaft during a power stroke to produce drive torque. Exhaust gas resulting from the combustion within the cylinder 28 is forced out through an exhaust manifold 46 when an exhaust valve 48 is in an open position. An exhaust camshaft (not shown) regulates a position of the exhaust valve 48.

An exhaust treatment system 52 may treat the exhaust gas. The exhaust treatment system 52 may include an oxidation catalyst (OC) 54 (e.g., a diesel OC), an SCR catalyst 56 (hereinafter “SCR 56”), and optionally, a particulate filter (PF) 58 (e.g., a diesel PF) which may be disposed between the OC and the SCR. It is further understood that the DEF injector is disposed upstream from the SCR. The OC 54 oxidizes carbon monoxide and hydrocarbons in the exhaust gas. The PF 58 removes particulate matter in the exhaust gas. The SCR 56 uses a reducing agent via the DEF injector 62 to reduce NOx in the exhaust gas.

The engine system 20 includes a dosing system 60. The dosing system 60 stores the DEF reducing agent. For example, the reducing agent may include a urea/water solution. The ECM 32 actuates the dosing system 60 and a reducing agent injector 62 (hereinafter “injector 62”) to control an amount of the reducing agent injected into the exhaust gas upstream of the SCR 56.

The reducing agent injected into the exhaust gas breaks down into NH₃ which may store on the SCR brick if not immediately consumed by the SCR chemical reactions. Accordingly, the ECM 32 controls an amount of NH₃ supplied to the SCR 56. As indicated, the SCR 56 adsorbs (i.e., stores) NH₃ on the brick. The amount of NH₃ stored by the SCR 56 may be referred to hereinafter as an “NH₃ storage level.” The ECM 32 may regulate the NH₃ storage level by injecting DEF into the exhaust gas just upstream of the SCR. NH₃ stored in the SCR 56 reacts with NOx in the exhaust gas passing through the SCR 56 such that Nitrogen and water are produced instead of NOx. NOx is particularly undesirable for the environment.

As shown in FIG. 1, the exhaust treatment system 52 may include a first NOx sensor 64 and a second NOx sensor 65. Each NOx sensor 64, 65 generates a NOx signal that indicates an amount of NOx in the exhaust gas. The first NOx sensor 64 may be positioned upstream from the injector 62 and may indicate the amount of NOx entering the SCR 56. The signal generated by the first NOx sensor 64 may be called a NOxᵢₙ signal. The second NOx sensor 65 may be positioned downstream from the SCR 56 and may indicate the amount of NOx exiting the SCR 56. The signal generated by the second NOx sensor 65 may be called a NOxₒᵤₜ signal. These sensors may also be capable of detecting the NH₃ that enters and leaves the SCR.

Referring back to FIG. 1, the engine system 20 may include exhaust temperature sensors 66-1, 66-2, and 66-3 (collectively exhaust temperature sensors 66). Each of the exhaust temperature sensors 66 generates exhaust temperature signals that indicate a temperature of the exhaust gas. The ECM 32 may determine the temperature of the SCR 56 based on the exhaust temperature signals. While three temperature sensors 66 are shown in FIG. 1, the engine system 20 may include more or less than three exhaust temperature sensors 66.

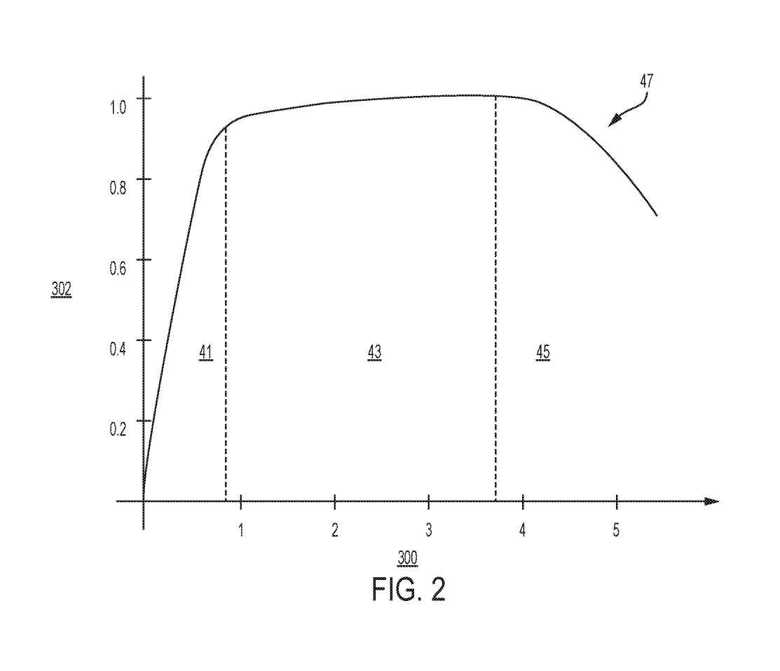

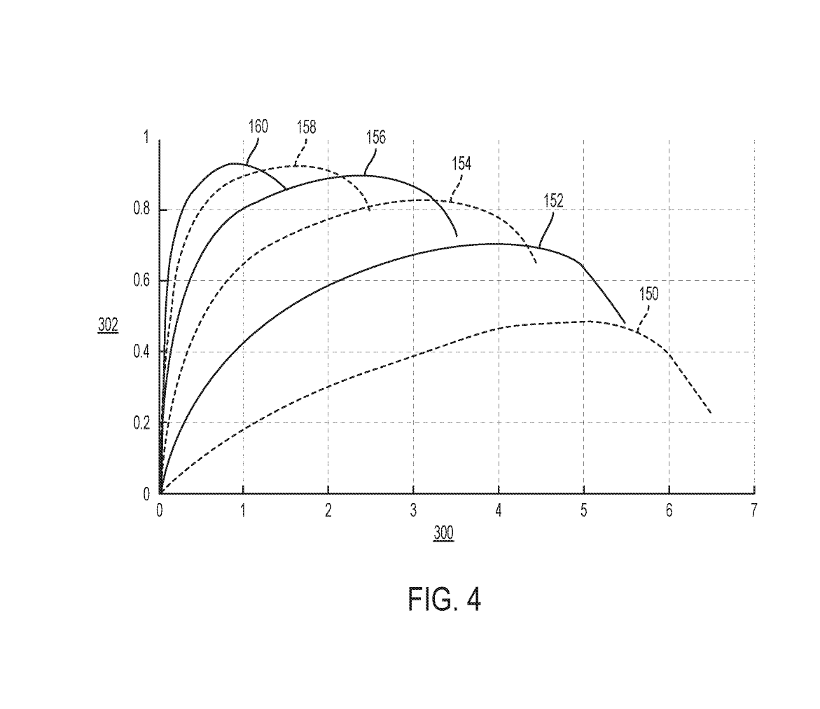

The percentage of NOx that is removed from the exhaust gas entering the SCR 56 may be referred to as the conversion efficiency of the SCR 56. The ECM 32 may determine the conversion efficiency or conversion ratio (shown as 302 in FIGS. 2 and 4) of the SCR 56 based on the NOxᵢₙ and NOxₒᵤₜ signals. For example, the ECM 32 may determine the conversion efficiency of the SCR 56 based on the following equation:

$${Efficiency}_{SCR} = \frac{{NOx}_{i n} - {NOx}_{out}}{{NOx}_{i n}}$$

where Efficiency_{SCR} represents the conversion efficiency of the SCR 56, and NOxᵢₙ and NOxₒᵤₜ represent the amount of NOx indicated by the NOxᵢₙ and NOxₒᵤₜ signals from the corresponding sensors shown in FIG. 1 respectively.

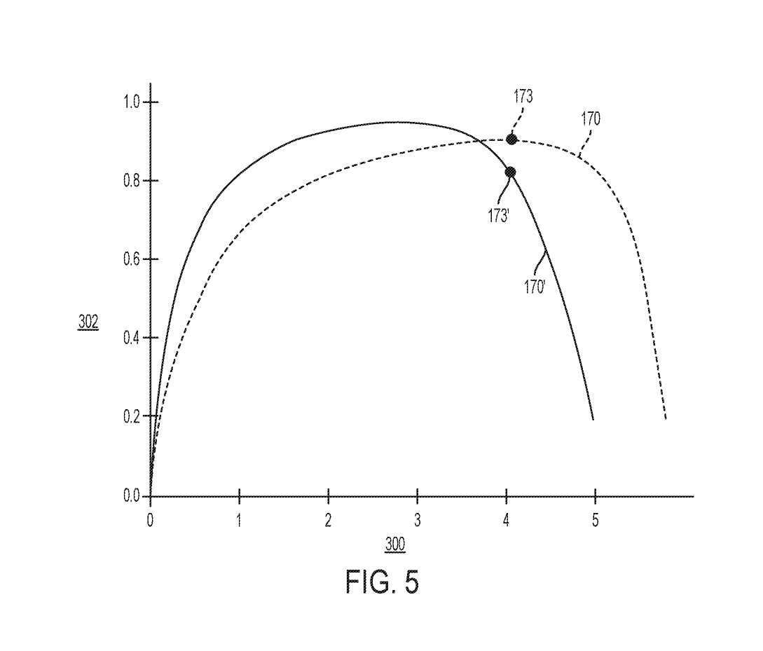

As shown in FIG. 4, the conversion efficiency of the SCR 56 may be related to the amount of NH₃ stored on the brick of the SCR 56 and the temperature. Referring now to FIG. 5, T1 curve 150 represents how the conversion ratio changes as the NH₃ storage level changes at 150 degrees Celsius. T2 curve 152 represents how the conversion ratio changes as the NH₃ storage level changes at 200 degrees Celsius. T3 curve 154 represents how the conversion ratio changes as the NH₃ storage level changes at 250 degrees Celsius. T4 curve 156 represents how the conversion ratio changes as the NH₃ storage level changes at 300 degrees Celsius. T5 curve 158 represents how the conversion ratio changes as the NH₃ storage level changes at 350 degrees Celsius. T6 curve 160 represents how the conversion ratio changes as the NH₃ storage level changes at 400 degrees Celsius.

Accordingly, the ECM 32 may control the amount of reducing agent injected into the exhaust gas to control the conversion efficiency of the SCR 56 as temperature changes. Maintaining the NH₃ storage level of the SCR 56 near a maximum NH₃ storage level ensures that a maximum conversion efficiency is achieved. However, maintaining the NH₃ storage level at or near the maximum NH₃ storage level also increases the possibility of NH₃ slip. As indicated, the second NOx sensor 65 is cross-sensitive to NH₃ and can identify NH₃ levels as well as NOx levels. Accordingly, the NOxₒᵤₜ signal may indicate both the amount of NOₓ and the amount of NH₃ in the exhaust gas flowing out of the SCR 56.

As shown in FIG. 5, an increase in the temperature of the SCR 56 may cause NH₃ slip given that the conversion ratio changes as temperature changes. Therefore, the graphs in FIGS. 4 and 5 demonstrate that the optimum NH₃ storage level for an SCR decreases as temperatures increase. Accordingly, based on the data from FIGS. 2 and 5, it is understood that NH₃ may desorb from the SCR 56 when the temperature of the SCR 56 increases at times when the NH₃ storage level is near to the maximum NH₃ storage level.

NH₃ slip may not occur in the low and optimal storage ranges because most of the injected NH₃ is adsorbed by the SCR 56 and/or reacts with NOx. Therefore, at such ranges, the NOxₒᵤₜ signal primarily reflects any NOx in the exhaust gas and little or no NH₃. Accordingly, as the NH₃ storage level increases from the low storage range 41 to the optimal storage range 43, the NOxₒᵤₜ signal decreases relative to the NOxᵢₙ signal (i.e., the conversion efficiency increases). However, when the NH₃ storage level increases from the optimal storage range 43 into the over-storage range 45, NH₃ slip is more likely as shown in FIG. 2. Portion 47 of the curve shows that NH₃ slip may occur given that the conversion ration decreases at this portion of the curve.

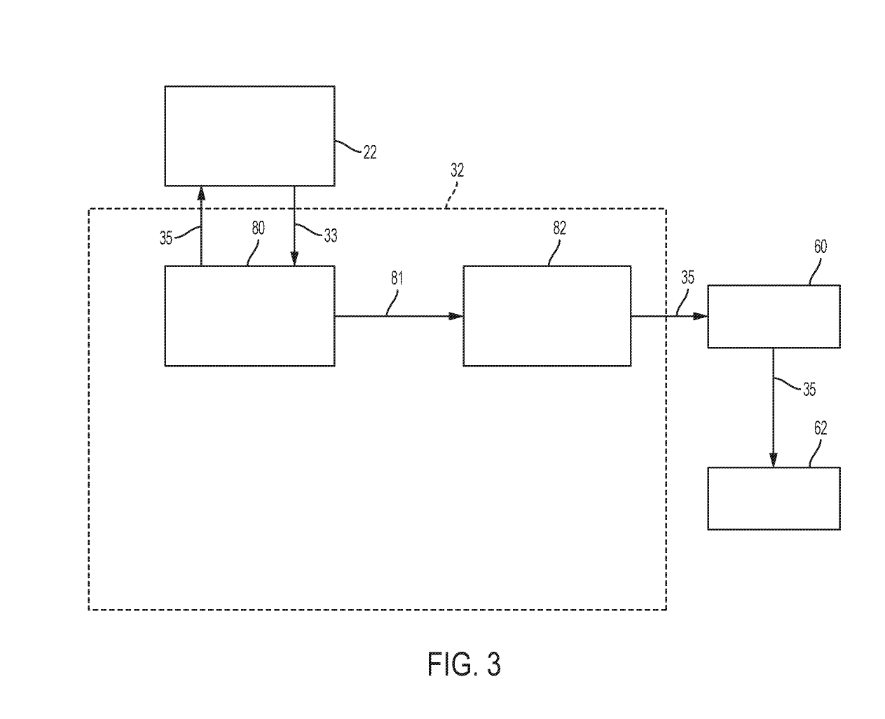

Referring now to FIG. 3, the ECM 32 includes a storage control module 80 and an injector control module 82. The ECM 32 receives input signals 33 from the engine system 20. The input signals include, but are not limited to exhaust temperature, and NOₓ signals. The ECM 32 processes the input signals and generates timed engine control commands 35 that are output to the engine system 20. The engine control commands 35 may actuate the fuel injectors 42, the dosing system 60, and the injector 62. The present disclosure provides for a method to prevent both NOₓ breakthrough and NH₃ slip when the SCR temperature increases and/or when exhaust gas mass flow increases.

The storage control module 80 of the ECM 32 determines an NH₃ storage set-point 81 (hereinafter “set-point”) of the SCR 56 based on the SCR model. The set-point may indicate a target storage level for given operating conditions (e.g., a temperature of the SCR 56). This determination is important in order to prevent NH₃ slip as shown in FIGS. 2 and 4. Again, as shown in FIG. 2, if the actual NH₃ load puts the SCR brick in an over-storage condition, then NH₃ slip is more likely to occur. Thus, NH₃ slip may occur at relatively low storage levels as the temperature of the SCR increases given that the optimum storage level can change with temperature. Accordingly, based on the data shown in FIG. 4, the storage control module 80 may therefore dictate a lower NH₃ storage level set point at relatively higher, yet steady, temperatures (350 or above) in order to prevent NH₃ slip given that the conversion efficiency of the SCR is dependent on a lower NH₃ storage level as the temperature of the SCR increases.

Accordingly, the NH₃ set-point may indicate a storage level (S) of the SCR 56 and a temperature (T) of the SCR 56. The set-point may be denoted as (S, T). The injector control module 82 controls the amount of the DEF reducing agent injected into the exhaust gas to adjust the NH₃ storage level on the SCR 56 to the set-point. For example, the injector control module 82 (shown in FIG. 3) may increase or decrease the storage level via injecting or stopping DEF dosages to reach the desired set-point after the requisite data is collected and a new set-point is determined. Additionally, the injector control module 82 may increase or decrease the storage level to maintain the set-point when the set-point has been reached.

Referring now to FIG. 5, the graph illustrates how the optimum storage level may shift when the temperature of the SCR 56 changes. The conversion ratio curve 170 at 250 degrees Celsius is compared with the conversion ratio curve 170′ at 300 degrees Celsius. Specifically, the graph illustrates that an optimum storage level at 250° C. may not be an optimum storage level at 300° C. and therefore, the increase in temperature from 250° C. to 300° C. may result in NH₃ slip. This condition is likely to occur where the load on the NH₃ set-point is at its maximum level. NH₃ slip may also occur at lower storage levels if the temperature of the SCR 56 increases given that optimum storage level changes according to temperature. Accordingly, the optimum storage level may shift to a lower storage level when the temperature of the SCR 56 increases. The storage control module 80 may therefore seek to decrease the storage level to decrease the chance of NH₃ slip and maintain the conversion efficiency of the SCR 56 when the temperature of the SCR 56 increases and/or when exhaust gas mass flow increases as well.

However, there may be a slight difference in timing between the storage control module 80 of the ECM 32 relative to actual conditions which may result in having insufficient levels of NH₃ on the SCR brick. For example, the initial operating conditions may include steady state operating conditions where the temperature of the SCR 56 may be constant. Accordingly, the storage control module 80 may determine the initial set-point based on a constant SCR temperature. When the SCR 56 is operating at steady state operating conditions with no temperature perturbations, the SCR 56 may operate at a peak of the conversion ratio curve, thereby maximizing NOx conversion efficiency without NH₃ slip. Operation of the SCR 56 at the peak of the conversion ratio curve 170 is illustrated in FIG. 5 at 250° C. However, when there is a sudden temperature increase to 300 degrees Celsius (or when there is an exhaust gas mass flow increase), the conversion ratio curve 170′ changes from its initial position at 170 and the storage control module adjusts the set point according to the higher temperature given that the optimum storage level decreases from data point OSL 173 to OSL′ 173′. By lowering the set-point, NH₃ slip is less likely to occur.

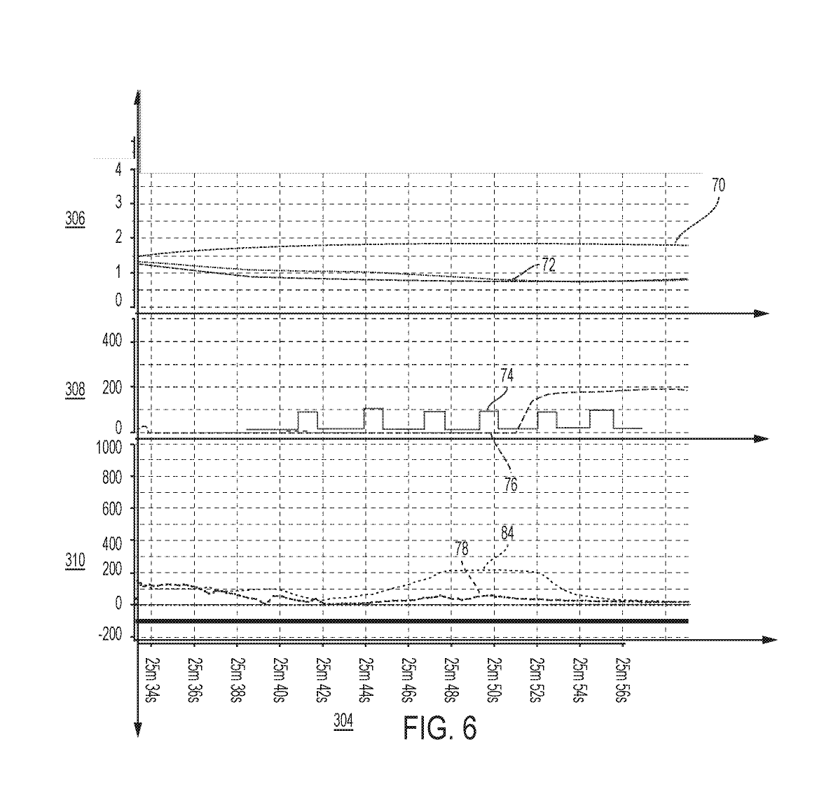

With reference to FIG. 6, graph data for an SCR temperature 70, NH₃ load 72, DEF dosages 74, 76 and NOx outputs 78 of an SCR after there is an increase in temperature. Temperature curve 70 illustrates a temperature increase. Ammonia curve 72 illustrates the decreasing ammonia load on the brick where the ammonia load decreases as a result of the increased temperature and the aforementioned change in optimum conversion efficiency. The percentage based DEF dosage curve 74 is shown where DEF is provided in a percentage based manner according to the present disclosure. In contrast, DEF curve 76 illustrates a condition where DEF is not injected during the temperature increase. As shown, in the “Percent DEF NOx Output Curve” 78, the NOx output from the SCR is significantly reduced when percentage based DEF (see curve 74) is provided. In cases where no DEF is provided (see curve 76) the “NOx Breakthrough Curve” 84 shows higher levels of NOx in the SCR output. Reference numeral 304 along the X axes refers to time in the unit of seconds while reference numeral 306 on the Y axis refers temperature (in degrees C.), reference numeral 308 refers to DEF dosage and reference numeral 310 refers to NOx breakthrough.

Accordingly, the present disclosure provides for a new method in which DEF dosing continues in relatively small amounts (based on a calibrated injection frequency map via the SCR model) for an “intervening phase.” The aforementioned DEF dosing of the present disclosure may illustrated as the “Percentage Based DEF Dosage Curve” (element 74 in FIG. 6). The intervening phase occurs after the temperature or exhaust gas mass flow increases (and the NH3 storage set point is lowered). This intervening phase is not intended to be a fixed time period. Rather, the intervening phase is defined by the model as the phase which occurs after the temp increase or exhaust gas mass flow increase wherein the estimated NH3 load as determined by the SCR model has an unacceptable deviation (per the calibration) from the NH3 setpoint. Accordingly, this intervening phase occurs until: (1) the load on the SCR brick is consumed to meet the new/lower set point; or (2) the SCR temperature falls back to a level appropriate for the actual NH3 load levels on the SCR brick; or (3) the exhaust gas mass flow falls back to a level appropriate for the actual NH3 load levels on the SCR brick. The continued dosing during the “intervening phase” provides for DEF injection at a rate based on a calibrated injection frequency map via the SCR model. Therefore, the continued dosing provides for adequate NH₃ to interact with the exhaust gas (at an increased temperature and/or increased exhaust gas flow) until the actual load on the SCR decreases to its optimum storage level.

Referring back to FIG. 4, the illustrated curves may represent exemplary output of the SCR model for a set of fixed operating conditions. The Y-axis 302 reflects the conversion ratio of the SCR while the X-axis 300 reflects the ammonia storage level. As shown, the conversion ratio 302 for the SCR may depend on the temperature of the SCR 56. The temperature of the SCR 56 ranges from 150° C. to 400° C. in FIG. 4. The SCR model of the present disclosure may, but not necessarily determine the (optimum) storage level based on several factors which include but are not limited to the following factors: temperature of exhaust gas, exhaust gas mass flow, an amount of NOx flowing into the SCR 56, a flow rate of the exhaust gas entering the SCR 56, and an amount of NH₃ entering the SCR 56. Accordingly, the SCR model, and more specifically the conversion ratio 302 and optimum storage levels, may be based on multiple parameters.

In contrast to traditional diesel after-treatment methods, the DEF dosing of the present disclosure continues at a lower rate after there is a sudden SCR temp increase or after there is an increase in the exhaust gas mass flow. The DEF dosing is decreased in order to reduce the NH₃ load on the brick while preventing NH₃ slip. However, the DEF dosing continues at a reduced rate (as shown by curve 74 in FIG. 6) until one of three conditions occurs: (1) the load on the SCR brick is consumed to the new/lower set point; or (2) the SCR temperature falls; or (3) the exhaust gas mass flow falls back to a level appropriate for the actual NH₃ load levels on the SCR brick. This time period may be called the “intervening phase.” However, during this “intervening phase,” NOx breakthrough is substantially reduced given that DEF is still supplied to the higher temperature exhaust, albeit at a lower rate. Therefore, the method of the present disclosure significantly reduces NOx emissions that result from NOx breakthrough that may otherwise occur during this time period.

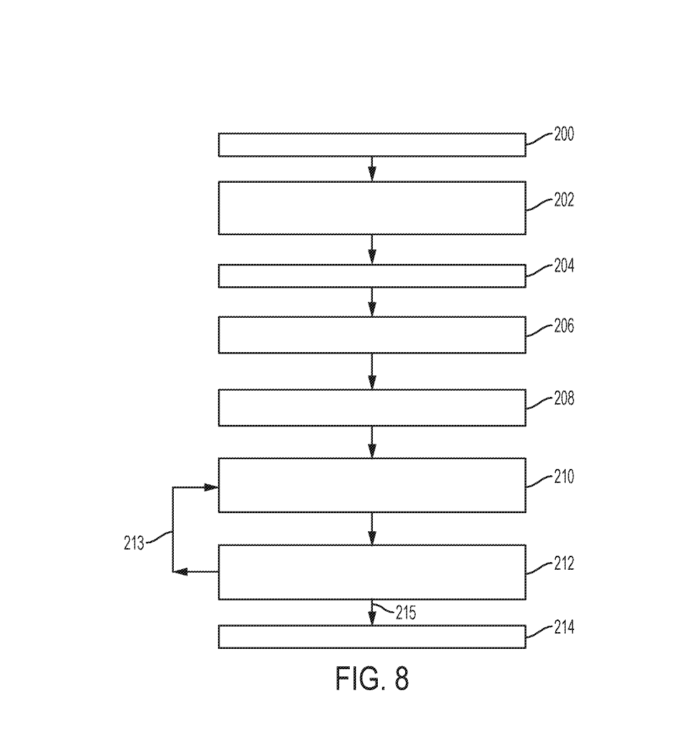

Accordingly, as shown in FIG. 8, the present disclosure provides a method where the SCR control module engages in the following method: (1) monitoring states of parameters of the exhaust gas, including but not limited to SCR exhaust temperatures 200 (and/or exhaust gas mass flow); (2) identifying at least one of an exhaust gas flow increase and a temperature increase at the SCR 202; (3) identifying the new lower ammonia set-point according to the temperature increase or increased exhaust gas mass flow 204; (4) identifying the rate upon which NH₃ is being used up (or desorbed) from the SCR brick upon reaching the higher temperature 206; (5) determining the “intervening phase” where the NH₃ will be used up on the brick based on the rate upon which NH₃ is being consumed on the SCR brick 208; (6) providing a percentage-based dosage of DEF, during the intervening phase (based on a calibrated injection frequency map via the SCR model) to prevent NOₓ breakthrough 210; and (7) determining whether intervening phase has expired 212 by comparing the estimated storage level against the set point to see if the deviation (if any) is acceptable. If the intervening phase has not expired 213, then the method loops back to step 210 where percentage based dosage of DEF is provided. Otherwise, if the intervening phase has expired 215, then the method of the present disclosure ends at step 214.

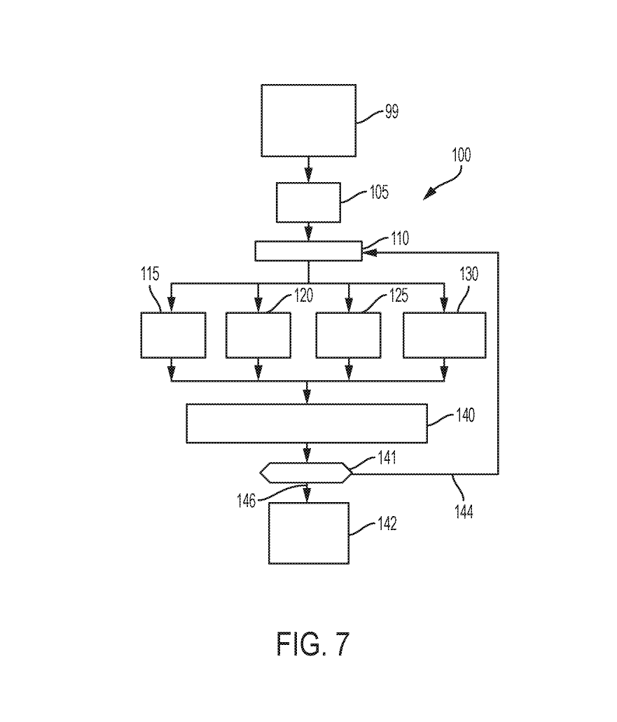

The method of the present disclosure specifically determines the rate of NH₃ is being consumed and the cumulative NH₃ storage concentration for the SCR via an algorithmic process 100 (shown in FIG. 7). With reference to FIG. 7, a schematic diagram of an example algorithmic process 100 for determining the cumulative NH₃ storage concentration for the SCR brick is provided where the algorithmic process 100 sequentially determines ammonia storage for each brick element to provide NH₃ storage for the entire SCR brick. This non-limiting example process 100 determines ammonia storage in a stepwise fashion for each of discrete substrate element of the SCR brick over an elapsed period of time for an SCR catalyst.

With reference to FIG. 7, input gas concentrations 99 that enter the SCR are NO, NO₂, O₂, N₂O, and NH₃. The algorithmic process 100 then determines a change in ammonia storage for each of the discrete substrate elements (i) over an elapsed time period in order to identify the total ammonia storage concentration (θ_{NH3}) on the coated substrate based thereon. Determining a change in the ammonia storage concentration (θ_{NH3}) includes sequentially determining a change in ammonia storage in a stepwise fashion for each of the discrete substrate elements in an SCR brick (52(i), i=1 through n), over an elapsed time period Δt based upon the concentrations of the input gases 99 of nitrogen oxide [NO]in, nitrogen dioxide [NO2]in, nitrous oxide [N2O]in, oxygen [O2]in, and ammonia [NH3]in and substrate temperature. This includes determining, for each discrete substrate element (i) (110) for each elapsed time period Δt (105), an amount of ammonia that is adsorbed (115), an amount of ammonia that is desorbed (120), an amount of ammonia that is oxidized (125), and an amount of ammonia that is consumed during reduction of NOx in the exhaust gas feedstream (130). The amounts of ammonia that is adsorbed (115), desorbed (120), oxidized (125), and consumed during reduction of NOx (130) can be in any suitable units of measure, including, e.g., mass, volume, or moles.

A non-limiting example of the step of determining the amount of ammonia that is consumed for NOx reduction (130) may be performed according to the following equation:

$${Δ [ NH 3 ]}_{NOx\_conversion} = \{ {[ {NO}_{x} ]}_{i n} + {\frac{{t}_{resident}}{Δ t} [ {NO}_{x} ]}_{- Δ t} + {Δ [ NH 3 ]}_{oxid\_NO} \} x \qquad [ 1 ]$$

A non-limiting example of the step of determining the amount of ammonia that is adsorbed (115) may performed according to the following equation:

$${Δ [ NH 3 ]}_{adsorption} = {η}_{adsorption} ( {[ NH 3 ]}_{i n} + {\frac{{t}_{resident}}{Δ t} [ NH 3 ]}_{- Δ t} + {Δ [ NH 3 ]}_{desorption} ) \qquad [ 2 ]$$

wherein an adsorption efficiency term η_{adsorption} is preferably selected from a predetermined array F_{table}_{_}_{adsorp}(T_{sub},ξ_{adsorp}) that is stored in tabular form in the control module 10. A specific value for the adsorption efficiency term η_{adsorption} correlates to substrate temperature T_{sub} and an adsorption capacity term ξ_{adsorp}, which are described as follows:

η_{adsorption}=F_{table}_{_}_{adsorp}(T_{sub},ξ_{adsorp})

$${ξ}_{adsorp} = ( 1 - {θ}_{NH 3} ) * Ω * \frac{{t}_{resident}}{\frac{{t}_{resident}}{Δ t} + 1} \qquad [ 3 ]$$

Wherein the variables are defined as follows:

[NH3]_{-Δt} is the NH3 concentration in the discrete substrate element 52(i) at previous timestep;

[NH3]ᵢₙ is the NH3 concentration at the inlet to the discrete substrate element 52(i);

T_{sub} is the substrate temperature of the discrete substrate element 52(i);

Δt is the elapsed time period;

θ_{NH3} is the ammonia storage concentration for the discrete substrate element 52(i);

t_{resident} is the gas resident time, which can be determined based upon the volume of the discrete substrate element 52(i) and the volumetric flowrate of the exhaust gas feedstream; and

Ω is a specific ammonia storage capacity for the discrete substrate element 52(i), which is preferably stored in the control module 10, and is considered a constant. The specific ammonia storage capacity can be in any suitable units of measure, including, e.g., mass, volume, or moles, and is preferably consistent with other measurements and estimates of ammonia storage capacity. Accordingly, with known states for each of the aforementioned parameters, i.e. [NH3]₁ₙ, [NH3]_{-Δt}, Δ[NH3]_{desorption}, T_{sub}, θ_{NH3}, and t_{resident}, the amount of ammonia that is adsorbed in the discrete substrate element (i), i.e., Δ[NH3]_{adsorption} can be determined.

A non-limiting example of the step of determining the amount of ammonia that is desorbed, i.e., Δ[NH3]_{desorption} 120 may be calculated according to the following equation:

Δ[NH3]_{desorption}=F_{table}_{_}_{desorp}(T_{sub},θ_{NH3})*θ_{NH3}*Ω*t_{resident} [4]

where this equation uses the specific ammonia storage capacity for the discrete substrate element 52(i) Ω, the residence time t_{resident}, and the ammonia storage concentration (θ_{NH3}) for the discrete substrate element 52(i) in combination with a predetermined desorption term F_{table}_{_}_{desorp}(T_{sub}, θ_{NH3}) as described above in Eq. 4. The predetermined desorption term F_{table}_{_}_{desorp}(T_{sub}, θ_{NH3}) is selected from a predetermined array of values stored in a memory lookup table, and is associated with the substrate temperature T_{sub} and ammonia storage concentration (θ_{NH3}) for the discrete substrate element 52(i).

A non-limiting example of the step of determining the amount of ammonia that is oxidized 125 may be performed according to the following equation:

Δ[NH3]_{oxidation}=[NH3]_{oxid}_{_}_{N}_{₂}+Δ[NH3]_{oxid}_{_}_{NO}+Δ[NH3]_{oxid}_{_}_{N}_{₂}_{O} [5]

The terms of Eq. 5 include an amount of ammonia oxidized in forming nitrogen, i.e., Δ[NH3]_{oxid}_{_}_{N}_{₂}, an amount of ammonia oxidized in forming NO, i.e., Δ[NH3]_{oxid}_{_}_{N}_{₂}_{O}, and an amount of ammonia oxidized in forming N₂O, i.e., Δ[NH3]_{oxid}_{_}_{N}_{₂}_{O}, which can be determined as described below. The aforementioned terms include predetermined oxidation terms F_{table}_{_}_{oxid}_{_}_{N}_{₂}, F_{table}_{_}_{oxid}_{_}_{NO} and F_{table}_{_}_{oxid}_{_}_{N}_{₂}_{O} that are selected from corresponding predetermined arrays that are preferably stored in tabular form in the control module 10. Specific values for each of the predetermined oxidation terms correspond to the substrate temperature T_{sub} and ammonia storage concentration (θ_{NH3}) for the discrete substrate element 52(i) as follows:

Δ[NH₃]_{oxid}_{_}_{N}_{₂}=F_{table}_{_}_{oxid}_{_}_{N}_{₂}(T_{sub},θ_{NH3})*[O₂]*Ω*t_{resident} (A) [6]

Δ[NH₃]_{oxid}_{_}_{NO}=F_{table}_{_}_{oxid}_{_}_{NO}(T_{sub},θ_{NH3})*[O₂]*Ω*t_{resident} (B) [7]

Δ[NH₃]_{oxid}_{_}_{N}_{₂}_{O}=F_{table}_{_}_{oxid}_{_}_{N}_{₂}(T_{sub},θ_{NH3})*[O₂]*Ω*t_{resident} (C) [8]

Wherein [O₂] is oxygen concentration, t_{resident} is a gas resident time in the discrete substrate element 52(i), θ_{NH3} is the ammonia storage concentration, and S2 is the specific ammonia storage capacity for the discrete substrate element 52(i).

Thus, a non-limiting example of the step of determining the amount the ammonia storage concentration (θ_{NH3}) 140 can be performed according to the following equation:

$${θ}_{NH 3 , t} = {θ}_{NH 3 , t - Δ t} + ( {Δ [ NH 3 ]}_{adsorption} - {Δ [ NH 3 ]}_{desorption} - {Δ [ NH 3 ]}_{oxidation} - {Δ [ NH 3 ]}_{NOx\_conversion} ) ( \frac{Δ t}{Ω {t}_{resident}} ) \qquad [ 8 ]$$

wherein Δ[NH3]_{adsorption} includes an amount of ammonia adsorbed into a catalyst surface per volume of gases passing through the discrete substrate element (i), [NH3]_{desorption} includes an amount of ammonia desorbed from catalyst surface per volume of gases passing through the discrete substrate element (i), Δ[NH3]_{oxidation} includes an amount of ammonia oxidized per volume of gases passing through the discrete substrate element (i), and [NH3]_{NOx}_{_}_{conversion} includes an amount of ammonia consumed for NOx reduction per volume of gases passing through the discrete substrate element (i).

The chemical species concentrations for the discrete substrate element (i) can be determined for NO, NO₂, ammonia, and N₂O concentrations as follows.

$$\begin{matrix}[ NO ] = \frac{\begin{matrix}( 1 - {R}_{{NO}_{2}} ) ( 1 - {η}_{{NO}_{x}} ) ( 1 - {η}_{NO} ) \\ ( {[ {NO}_{x} ]}_{i n} + {\frac{{t}_{resident}}{Δ t} [ {NO}_{x} ]}_{- Δ t} + {Δ [ NH 3 ]}_{oxid\_NO} )\end{matrix}}{( 1 + \frac{{t}_{resident}}{Δ t} )} & [ 9 ] \\ [ {NO}_{2} ] = \frac{\begin{matrix}[ {R}_{{NO}_{2}} - {η}_{{NO}_{x}} ( 1 - {R}_{{NO}_{2}} ) ] ( 1 - {η}_{{NO}_{2}} ) \\ ( {[ {NO}_{x} ]}_{i n} + {\frac{{t}_{resident}}{Δ t} [ {NO}_{x} ]}_{- Δ t} )\end{matrix}}{( 1 + \frac{{t}_{resident}}{Δ t} )} & [ 10 ] \\ [ NH 3 ] = \frac{\begin{matrix}( 1 - {η}_{adsorption} ) \\ ( {[ NH 3 ]}_{i n} + {\frac{{t}_{resident}}{Δ t} [ NH 3 ]}_{- Δ t} + {Δ [ NH 3 ]}_{desorption} )\end{matrix}}{( 1 + \frac{{t}_{resident}}{Δ t} )} & [ 11 ] \\ [ {N}_{2} O ] = \frac{( {[ {N}_{2} O ]}_{i n} + {\frac{{t}_{resident}}{Δ t} [ {N}_{2} O ]}_{- Δ t} + Δ [ {N}_{2} O ] )}{( 1 + \frac{{t}_{resident}}{Δ t} )} & [ 12 ]\end{matrix}$$

wherein [NO]_{-Δt}, [NO₂]_{-Δt}, [N₂O]_{-Δt} and [NH3]_{-Δt} are the concentration values in the discrete substrate element 52(i) defined at the previous timestep for NO, NO₂, and N₂O.

Δ[N₂O]=Δ[NH3]_{oxid}_{_}_{N}_{₂}_{O}+Δ[N₂O]_{NO}_{₂}+Δ[N₂O]_{NO} [13]

Δ[N₂O]_{NO}=Δ[NO]ᵢₙ(1−η_{NO}_{ₓ})η_{NO}γ_{table}_{_}_{NO}_{_}_{N}_{₂}_{O}(T_{sub}) [14]

Δ[N₂O]_{NO}_{₂}=([NO₂]ᵢₙ−η_{NO}_{ₓ}[NO]ᵢₙ)η_{NO}_{₂}γ_{table}_{_}_{NO}_{_{2—}}_{N}_{₂}_{O}(T_{sub}) [15]

wherein γ_{table}_{_}_{NO}_{_}_{N}_{₂}_{O} and γ_{table}_{_}_{NO}_{_{2—}}_{N}_{₂}_{O} are reaction rate terms that may be selected from a predetermined array that is stored in tabular form in the control module 10. A specific value for each of the reaction rate terms is retrievable as a function of the substrate temperature T_{sub}.

After the algorithm determines the NH3 storage and chemical species concentrations for each element 140, the algorithm then determines whether brick has been analyzed 141. If the last brick has not been analyzed 144, then the process loops back to step 110 where the next brick is analyzed. However, if the last brick has been analyzed 146, then the algorithm provides an output 142 for each discrete substrate element (i) that includes corresponding concentrations of output gases of nitrogen oxide [NO], nitrogen dioxide [NO2], nitrous oxide [N2O], ammonia [NH3], oxygen [O2], and a cumulative ammonia storage concentration [θ_{NH3}]. Thus, the SCR model may implement the above algorithms and the output 142 to determine ammonia storage concentration (θ_{NH3}) for the entire coated substrate by sequentially determining a change in ammonia storage for each of the discrete substrate elements in a stepwise fashion for each of the discrete substrate elements (i), i=1 through n, over an elapsed time period, and determining the ammonia storage concentration (θ_{NH3}) on the ammonia-selective catalyst reduction device corresponding to the change in ammonia storage for the discrete substrate elements (i).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method to reduce NO_{X} breakthrough when the SCR is increasing in temperature, the method comprising the steps of:
monitoring a plurality of parameters of an exhaust gas feed stream upstream of an ammonia-selective catalyst reduction device;
identifying one of a temperature increase at an SCR inlet or an exhaust gas flow increase at an SCR inlet;
identifying a new lower ammonia set-point;
determining an NH₃ consumption rate on the SCR brick, an estimated ammonia storage concentration on the SCR, and a percentage of NH₃ consumed by sequentially determining a change in ammonia storage for a plurality of discrete substrate elements on the SCR brick;
comparing the new lower ammonia set point against the estimated ammonia storage concentration to determine if a transient phase status exists; and
providing a percentage of DEF dosage equivalent to the percentage of NH₃ consumed during the transient phase to prevent NOₓ breakthrough and to prevent NH3 slip until the expiration of the intervening phase and steady state is achieved
wherein the percentage of DEF dosage does not deviate from the percentage of NH3 consumption during the transient phase.

2. The method as defined in claim 1 wherein the plurality of parameters includes at least one of an exhaust temperature at the SCR inlet and an exhaust temperature at the SCR outlet.

3. The method as defined in claim 1 wherein the step of identifying the new lower ammonia set point is based on at least one of an amount of NOx flowing into the SCR, a temperature of exhaust gas entering the SCR, a flow rate of the exhaust gas entering the SCR, an exhaust pressure upstream of the SCR, an NO₂ ratio, an amount of NH₃ entering the SCR, an oxygen concentration of the exhaust gas, and a prior NH₃ storage level of the SCR.

4. The method as defined in claim 1 wherein the intervening phase is defined as the time between one of the temperature increase or the exhaust gas mass flow increase, and the time when the actual amount of NH₃ stored on the SCR brick is equivalent to the new lower ammonia set-point.

5. (canceled)

6. The method as defined in claim 1 wherein the step of determining the NH₃ consumption rate on the SCR brick is further comprised of the steps of determining the amount of NH3 desorbed, determining the amount of NH₃ oxidized, and determining the amount of NH₃ consumed for NOx reduction.

7. The method as defined in claim 1 wherein the step of determining an NH₃ consumption rate on the SCR brick and determining an actual NH₃ storage concentration on the SCR brick is performed via an algorithmic model.

8. The method as defined in claim 1 wherein the intervening phase is defined as the phase after the temperature's initial increase to the time when the temperature decreases to a level which corresponds with the actual ammonia load on the SCR brick.

9. The method as defined in claim 1 wherein the intervening phase is defined as the phase after an exhaust gas flow increase to the time when an estimated ammonia level substantially corresponds with the new ammonia set-point.
